(19) United States
(12) Patent Application Publication
(10) Pub. No.: US 2021/0076126 A1
(43) Pub. Date: Mar. 11, 2021

(54) CONTROLLED RESONANCE TECHNOLOGY

(71) Applicant: GODFRIED F. A. VAN ROOIJ, BARRIE, Ontario (CA)

(72) Inventor: GODFRIED F. A. VAN ROOIJ, BARRIE, Ontario (CA)

(21) Appl. No.: 16/771,920

(22) PCT Filed: Dec. 14, 2018
(86) PCT No.: PCT/CA2018/000235

§ 371 Date: Jun. 11, 2020

Related U.S. Application Data
(60) Provisional application No. 62/598,714, filed on Dec. 14, 2017.

(51) Int. Cl. H04R 1/28; H04R 1/02; H04R 1/40; H04R 3/12

(52) U.S. Cl. CPC H04R 1/288; H04R 1/025; H04R 2201/028; H04R 3/12; H04R 2201/021; H04R 1/403

(57) ABSTRACT

A controlled resonance device, has a housing with a hollow interior, wherein the front side of the housing has an opening thereon. A sound panel is attached to the housing over the opening, to cover the opening. A plurality of resonators are spaced apart from each other inside the hollow interior of the housing and attached to the sound panel. The plurality of resonators are connected to an input so as to selectively induce vibration of the sound panel when activated.

### FIELD OF THE INVENTION

This invention relates to loudspeaker systems, in particular, to “invisible” loudspeaker systems for installation in wall, ceiling, or other engineered or architectural panels.

### BACKGROUND

Conventional loudspeakers have a paper cone attached to an electrical coil, which is suspended within a magnetic field. The coil and the attached paper cone vibrate in response to the interaction between a current flowing through the coil and the magnetic field surrounding the coil. By controlling the current, the vibration of the cone may be controlled to produce the desired sound.

Conventional speakers used in “invisible” loudspeaker applications have limited sound dispersion. Conversely, other types of in-wall loudspeakers generally have limited sound fidelity, compared to conventional speakers.

Other in-wall loudspeakers are available, but the sound they produce is dependent on the acoustic characteristics of the wall cavity or prefabricated enclosure in which they are mounted. Accordingly, there is a need for an in-wall loudspeaker that produces high-fidelity sound and is less/not dependent on the acoustics of the wall cavity in which it is mounted.

### SUMMARY OF THE INVENTION

A controlled resonance device, according to the present invention, has a housing with a hollow interior, a top, a bottom, and opposing front and rear sides defining a depth of the housing therebetween, wherein the front side has an opening thereon. A sound panel is attached to the housing over the opening, shaped to fit over and substantially cover the opening. A plurality of resonators are spaced apart from each other inside the hollow interior of the housing and attached to the sound panel. The plurality of resonators are connected to an input so as to selectively induce vibration of the sound panel when activated.

In another embodiment, the sound panel is attached to the housing over the opening so as to substantially seal the housing.

In another embodiment, at least a part of the rear side of the housing is angled relative to the front side of the housing.

In another embodiment, the rear side of the housing is angled toward the front side of the housing at the top and bottom of the housing.

In another embodiment, the hollow interior of the housing contains sound dampening insulation.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a partial cutaway view of the controlled resonance device, with a portion of the sound panel removed to show the internal components.

FIG. 2 is a perspective view of another controlled resonance device.

FIG. 3 is a perspective view of the controlled resonance device, shown in FIG. 2, with a mounting bracket attached for installation.

FIG. 4 is another perspective view of the controlled resonance device, shown being installed into a wall cavity.

FIG. 5 is a front view of the controlled resonance device, showing the installation step of securing the controlled resonance device in the wall cavity.

FIG. 6 is a front view of the controlled resonance device, showing the installation step of filling the gaps around the perimeter of the sound panel.

FIG. 7 is a front view of the controlled resonance device, showing the final installation step of painting over the controlled resonance device.

### DESCRIPTION OF THE INVENTION

The controlled resonance technology, according to the present invention, permits an “invisible” loudspeaker system to produce high quality sound without impacting the aesthetic of the room. In particular, a controlled resonance device, according to the present invention, uses resonators, located within a housing and attached to a sound panel, to bring the sound panel into motion, thereby producing sound waves. Each of the elements of the device cooperate with one other to produce the desired sound.

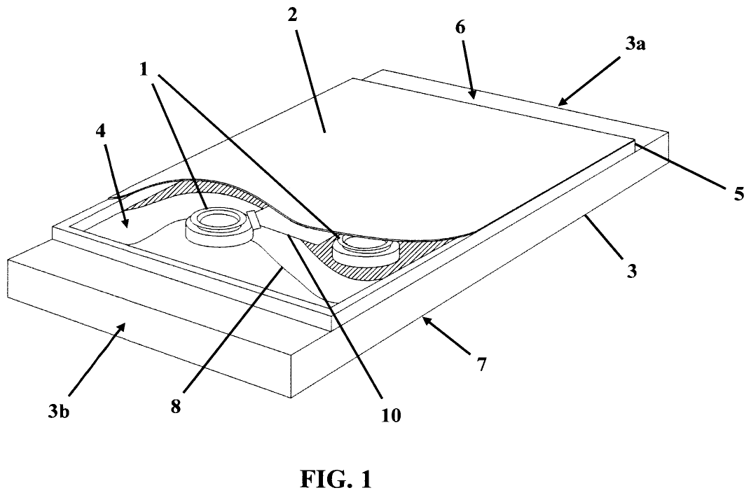

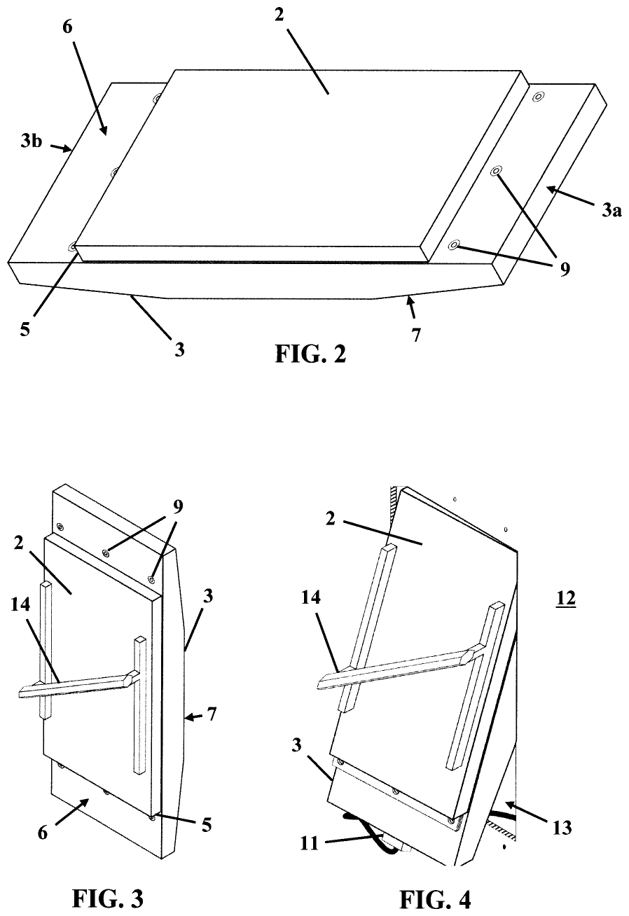

As shown in FIG. 1, the device has a plurality of resonators 1, attached to a sound panel 2 mounted on a housing 3. The housing 3 is a hollow, box-like structure with an opening 4 on one side. The opening 4 is rectangular and has a raised lip 5 surrounding the opening 4, which extends outwardly from the front 6 housing 3. As shown in FIG. 2, the rear 7 of the housing 3 has a triangular profile, such that the distance between the front 6 and rear 7 of the housing 3, or the depth d of the housing 3, tapers towards the ends. The hollow interior of the housing 3, between the front 6 and rear 7 of the housing 3, is filled with sound dampening insulation 8. Although the housing 3 and opening 4 are shown as being generally rectangular, either or both may be circular, oval, or otherwise shaped as desired for the particular application.

The sound panel 2 is shaped to fit over and cover the opening 4. The perimeter of the sound panel 2 is rigidly attached to the raised lip 5 surrounding the opening 4, and is preferably attached thereto so as to seal the housing 3. The sound panel 2 may be attached to the housing 3 using fasteners, such as screws, or adhesives. The material or materials used in the construction of the sound panel 2 may be selected for their desired acoustic characteristics or other mechanical properties, such as durability or paintability. Suitable materials are rigid, preferably light weight, and are solid or have a structural core, for example, wood, metal, paper, polymer, or glass and may be made with a single layer or a laminate of multiple layers of one or more materials. Preferably, the sound panel is made of an aluminium honeycomb core sandwiched between two layers of treated paper.

As shown in FIG. 4, the housing 3 may be mounted behind a wall 12, such that the opening 4 and the sound panel 2 fit within a hole 13 in the wall 12. The front 6 of the housing 3 extends outwardly from the opening 4 behind the wall 12, such that the front 6 of the housing 3 abuts the outward facing side of the wall 12. Preferably, the front 6 of the housing 3 extends outwardly from the opening 4 upwardly towards the top 3a of the housing 3 and downwardly towards the bottom 3b of the housing. As shown in FIGS. 3-5, a mounting bar 14 may be attached to the housing 3, through the sound panel 2 for maneuvering the device through the hole 13 in the wall 12 and positioning it for installation in the wall cavity. The sound panel 2 preferably has fastener holes therethrough to permit the mounting bar 14 to be attached to the housing 3 through the sound panel 2 during installation. Alternatively, the device may be mounted behind a panel or other wall covering and transfer sound through the panel or wall covering.

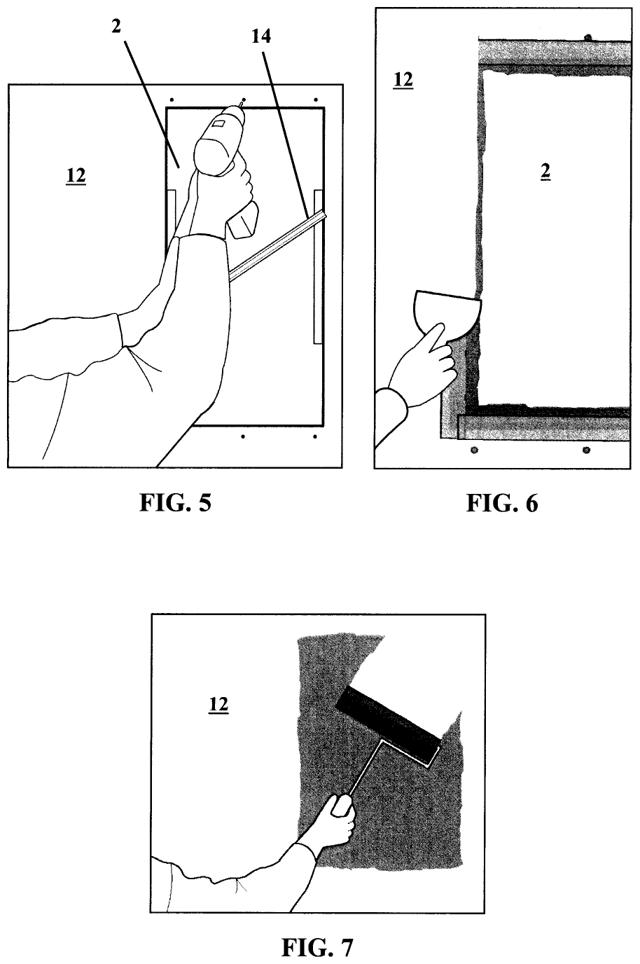

As shown in FIG. 2, the front 6 of the housing 3 is provided with fastener apertures 9, adjacent the opening 4, for receiving screws or other fasteners to secure the housing 3 in place behind the wall 12, as shown in FIG. 5. To complete the installation, any gaps between the raised lip 5 and the wall 12 may be filled, for example, using tape and a suitable filler compound, as shown in FIG. 6. Finally, as shown in FIG. 7, the sound panel 2 may be painted to blend in with the surrounding wall 12.

The sound dampening insulation 8 in the housing 3 reduces sound transfer through the rear 7 of the housing 3. Medium to high density packed fibres, such as fibreglass, mineral wool, or natural fibres such as cotton or wool, are preferably used as insulation 8 within the housing 3. Alternatively, acoustic foam, acoustic fabrics, mass loaded vinyl, paper, or other sound absorbing materials may be used as insulation 8. More than one type of material may also be combined to be used as insulation 8. The insulation 8 affects the acoustics of the device and reduces unwanted sound from the device being projected into an adjacent room. Sufficient space in the housing 3 is left unfilled with insulation 8 for the resonators 1 and other working components of the device.

As shown in FIG. 1, the resonators 1 are attached to the sound panel 2 on the side facing the housing 3, inside the hollow interior of the housing 3. The resonators 1 are spaced apart from each other about the sound panel 2 and the number and position of the resonators 1 may be adjusted to provide the desired acoustic properties. The resonators 1 are connected to a circuit board 10, which is preferably mounted within the housing 3 and includes the electrical loudspeaker components for receiving an electrical signal and controlling the resonators 1 to convert the electrical signal into sound. The resonators 1 and/or the circuit board 10 are mounted to flanges, braces, or other structural components of the housing 3. As shown in FIG. 1, the resonators 1 and/or the circuit board 10 may be partially surrounded by the insulation 8.

Preferably, the device acts as a passive speaker and is connected to a separate power amplifier. Alternatively, the device may act as a powered speaker, in which case the board 10 also includes or is connected to a power amplifier (not shown), which may be mounted within the housing 3 or outside the housing 3. In either case, the circuit board 10 is connected to an input 11 for receiving an audio signal, for example, the input may be a pair of speaker cable input terminals mounted on the outside of the housing 3, as shown in FIG. 4. Alternatively, another type of suitable wired or wireless input 11 may be used.

The resonators 1 are spaced apart from one another on the sound panel 2 in a configuration that produces the desired sound profile when the resonators 1 are activated to cause the sound panel 2 to vibrate. This configuration varies depending on the particular resonators 1 used, the structural characteristics of the housing 3, the acoustic properties of the sound panel 2 and the insulation 8, and the acoustic effect of the desired finishing application, such as filling and painting over the panel, as described above. Preferably, the configuration of the resonators 1 on the sound panel 2 is selected to produce a sound profile that covers a wide range of the audio spectrum with a flat frequency response. As used herein, the term “flat” with reference to a sound profile refers to a consistent output: input signal intensity ratio over the full operating frequency range.

When configuring the device for a particular application, mathematical modeling may be used to produce an approximate initial configuration. The device is then live tested to measure its frequency range and frequency response. The tests may also include simulation of the intended finishing application of the device, for example, installed in a wall cavity and filled and painted over, as shown in FIGS. 4-7. Any deficiencies in the sound profile, such as excessive variations in the frequency response over the frequency range, can be identified in such testing. The configuration of the device is accordingly set up, or “tuned”, to yield a device with the desired sound profile for a particular set of component parts and finishing application parameters.

Optionally, the board 10 may include components such as resistors, capacitors, and coils to fine tune the sound profile of the device. The board 10 may also include mechanical or electronic fuses, or other limiting devices, to protect the device from damage.

### Example Configuration

In one embodiment, configured for the device to be installed in a wall cavity, the housing 3 is made of aluminium and is 9¾″×23″×3⅛″. The insulation 8 is made of repurposed cotton and fills the interior of the housing 3, leaving sufficient room for the circuit board 10 and the resonators 1. The raised lip 5 extends 1″ from the front 6 of the housing 3 surrounding the opening 4, which is 9¾″×17″. There are four resonators 1 attached to the inside of the sound panel 2, within the hollow interior of the housing 3. The sound panel 2 is made of an aluminium core sandwiched between two layers of treated paper and is attached to the opening 4 by way of an adhesive applied about the perimeter of the sound panel 2, so as to substantially seal the housing 3.

A number of embodiments of the present invention have been described. Nevertheless, the embodiments are described herein illustratively and are not meant to limit the scope of the invention, as claimed. Variations of the foregoing embodiments will be evident to a person of ordinary skill and are intended by the inventor to be encompassed by the following claims.

What is claimed is:

1. A controlled resonance device, comprising:
a housing having a hollow interior, a top, a bottom, and opposing front and rear sides defining a depth of the housing therebetween, wherein the front side has an opening thereon;
a sound panel attached to the housing over the opening, shaped to fit over and substantially cover the opening; and
a plurality of resonators spaced apart from each other inside the hollow interior of the housing and attached to the sound panel, wherein the plurality of resonators are connected to an input so as to selectively induce vibration of the sound panel when activated.

2. The controlled resonance device of claim 1, wherein the sound panel is attached to the housing over the opening so as to substantially seal the housing.

3. The controlled resonance device of claim 1, wherein the housing has a raised lip about the opening extending outwardly from the front side of the housing.

4. The controlled resonance device of claim 3, wherein the front side extends outwardly from the raised lip on at least one side of the opening.

5. The controlled resonance device of claim 4, wherein the front side extends outwardly from the raised lip towards the top and towards the bottom of the housing.

6. The controlled resonance device of claim 5, wherein the front of the housing has a plurality of fastener apertures located thereon and adjacent to the opening.

7. The controlled resonance device of claim 1, wherein at least a part of the rear side of the housing is angled relative to the front side of the housing.

8. The controlled resonance device of claim 7, wherein the rear side of the housing is angled toward the front side of the housing at the top and bottom of the housing.

9. The controlled resonance device of claim 8, wherein the depth of the housing tapers from the centre to the top and bottom of the housing.

10. The controlled resonance device of claim 1, wherein the hollow interior of the housing contains sound dampening insulation.

11. The controlled resonance device of claim 10, wherein the sound dampening insulation comprises one or more materials selected from the group consisting of: fibreglass, mineral wool, acoustic foam, acoustic fabric, and mass loaded vinyl.

12. The controlled resonance device of claim 1, comprising a circuit board connected to the input and to the plurality of resonators.

13. The controlled resonance device of claim 12, comprising a power amplifier connected to the circuit board.
